(19) United States
(12) Patent Application Publication
(10) Pub. No.: US 2009/0009285 A1
(43) Pub. Date: Jan. 8, 2009

(54) Authentication of Re-Presentable Items

(76) Inventors: John Joseph Corry, Cheadle (GB); David Leslie McNeight, Wilmslow (GB)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/579,781

(22) PCT Filed: Apr. 28, 2005
(86) PCT No.: PCT/GB05/01627

§ 371 Date: Sep. 5, 2008

(30) Foreign Application Priority Data
Apr. 28, 2004 (GB) 0409429.8

(51) Int. Cl. G07D 7/00

(52) U.S. Cl. 340/5.86

(57) ABSTRACT

A system for authenticating re-presentable items, such as currency notes and passports, comprises applying to each item a unique code, reading the code on presentation, and checking the code against a database, characterised in that at each check, the code is altered.

This invention relates to the authentication of re-presentable items, such as currency notes which are circulated, passports and identity cards, which are presented on multiple occasions on crossing borders or to obtain access to restricted places or benefits.

Security printing—expensive, fine detail printing, on special paper, with watermarks, metal stripes, holograms and other artefacts—has long been relied upon to deter forgery. Technology available to counterfeiters make it easier to produce passable, if not, indeed, indistinguishable copies of genuine articles.

In the case of currency notes, the greatest threat comes not from back street operators with colour printers, but from well-financed, highly skilled organisations, working on an altogether larger scale.

It has recently been proposed to use Radio Frequency Identification (RFID) tags on currency notes. These are microchips with a printed aerial mounted on a flexible film. Hitachi Europe Ltd, of Maidenhead, Berkshire, UK produces such a tag which is intended to be incorporated in currency notes. The microchips can be accessed by a read/write device which energises and controls the chip via the aerial. Such devices can be comprised in hand-held units or built into portals through which items are passed.

RFID tags are available with several data registers. Usually, one register has a manufacturer-assigned code, in the form of a binary number, which can be up to 64 bits long, each tag having a different code. There are more than 18×10¹⁸ available numbers. The numbers are ‘burnt in’ to the register, which is to say, they cannot be altered or erased. It is understood that not all possible numbers are used, following, at least to some extent, the teaching of U.S. Pat. No. 4,463,250. The tag manufacturer will maintain a database of issued numbers, against which the number of any tag can be checked.

The ability to produce such tags is dependent on having, or having access to, a silicon foundry, which is an expensive plant. The idea behind protecting currency notes in this way appears to be that, even if the cost of setting up for the operation were not prohibitive, it would not be possible to generate the 64 bit numbers that would check out against the database.

If this is the reasoning, then it is flawed.

In the first place, the cost of setting up a silicon foundry would not be prohibitive to a counterfeiter intending to operate on a very large scale. A well-financed organisation could afford to do it, and would see the possibility of reaping rewards many times its investment. It is precisely such organisations, be they simply criminal, or be they intent on destabilising a currency for political ends, that are to be most feared.

Another flaw is the assumption that such an organisation could not produce tags with numbers that would check out against the genuine manufacturer's database.

It would be easy to produce tags with such numbers, simply by reading one number from a genuine note and producing all the spurious notes with that number.

U.S. Pat. No. 4,463,250 deals with that problem in this way, that each time a new number is read, it is checked against a database of already read numbers to check for repeats. There should not, of course, be any repeats. The production of millions of twenty dollar bills, all with the same number, would be rapidly detected. The smart counterfeiter will, having read U.S. Pat. No. 4,463,250, not produce all his notes bearing the same number. It is a simple matter to draw ten thousand, or a hundred thousand twenty dollar bills from a bank and copy the numbers into the chips—that would be facilitated by the ability to read the numbers by a read/write device, such being freely available, associated with a high speed note counting machine. The genuine notes can then be returned to the account from which they were withdrawn, the only cost being the loss of a day's bank interest.

Copies will be discovered, if the database check is set up to reveal repeats, of course, but only infrequently. And herein lies a major problem—with banknotes, which are in circulation, there would be no way to distinguish between a genuine note, presented twice, and a spurious note, presented after a genuine note had been presented.

The present invention solves that problem.

The invention comprises a system for authenticating re-presentable items, such as currency notes and passports, comprising applying to each item a unique code, reading the code on presentation, and checking the code against a database, characterised in that at each check, the code is altered.

This is capable of implementation using REID tags. The unique codes can comprise the manufacturer-assigned, burnt-in 64 bit numbers plus another number in a writable register in the microchip. That other number would effectively constitute an incrementing counter. Suppose it starts at binary 00000 when a currency note, say, is issued; when it is first checked, it is changed to 00001, then 00010 and so on, the register size being chosen to comfortably cover the anticipated number of re-presentations during the life of the currency note or other item—indeed, filling up of this register can be used to signal the end of that useful life.

Even if this feature is known to the counterfeiter, so that he will be smart enough to realise that, on repayment into his (or some other) account of the twenty dollar bills from which he copied, their counters will be incremented, the counters on the genuine and the spurious bills will rapidly get out of synchronism, and it will be immediately apparent from the database checks that this is so, indicating a problem, which can be investigated.

As an aid to any such investigation, additional information can be written, at each check, to the tag. Such information may comprise the date and place of the check, the place being indicated, for example, by a bank sort code or a similar code for a currency exchange or a retail establishment. There may not, of course, be sufficient space on the microchip to hold a complete history, but this information can be written over, being saved to the database.

Burnt in code can also, for example, hold information about the currency and denomination of a bank note, enabling note counting equipment also to count mixed currency and value notes, separating them into currency and denomination piles.

A further refinement involves the unique code itself, which can be backed up by an algorithm-generated check number, which will enable an on-the-spot check to be made, without reference to the database, to determine whether the unique code is an assigned number or not. Of course, if a counterfeiter has derived his code from a genuine item, the check number will also be copied. But, if not, passing the item through a checking device, which checks the algorithm-generated check number to see if it has been derived from the unique number by the proper algorithm, will give an instant indication, before the passer of the item has even left the bank, that a note is spurious.

Embodiments of system for authenticating re-presentable items according to the invention will now be described with reference to the accompanying drawings, in which:

FIG. 1 shows an RFID tag;

FIG. 2 is a diagrammatic illustration of the data registers on an RFID tag;

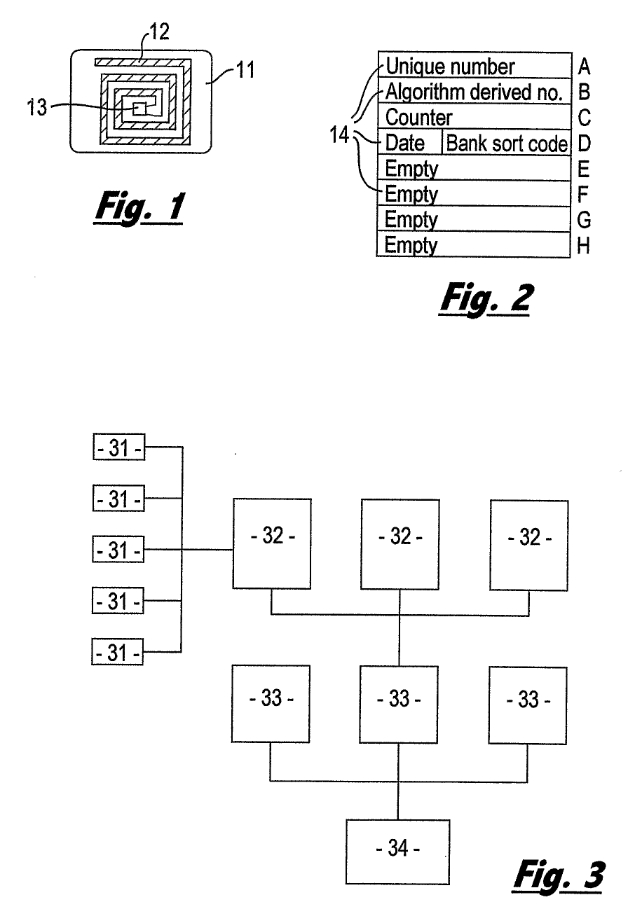

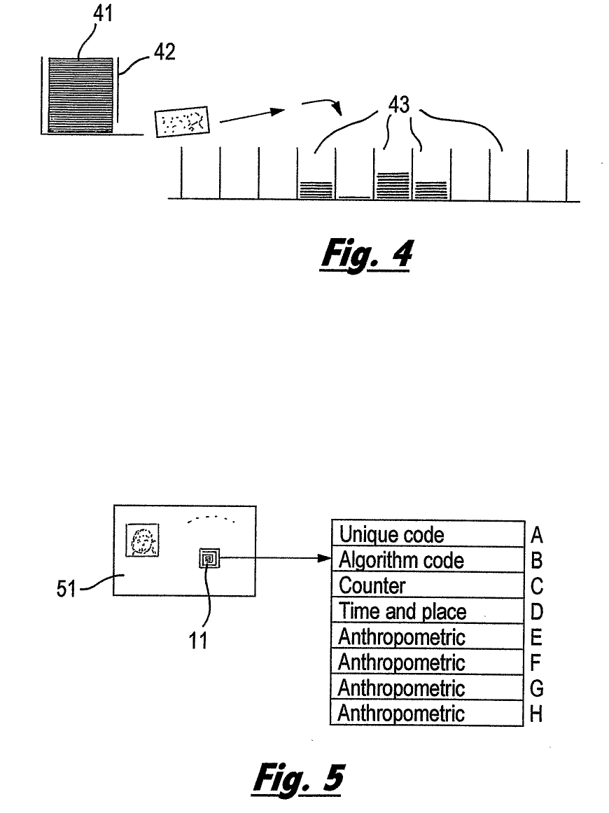

FIG. 3 is a diagrammatic illustration of a possible hierarchical structure for a database connection to check stations;

FIG. 4 is a diagrammatic illustration of a currency note reading, counting and sorting machine; and

FIG. 5 is a diagrammatic illustration of a passport/identity card authenticating system.

The drawings illustrate a system for authenticating re-presentable items, such as currency notes, passports and credit and debit cards, comprising applying to each item a unique code, reading the code on presentation, and checking the code against a database, characterised in that at each check, the code is altered.

In the embodiments, the system is realised through the use of read/write RFID tags. One such is illustrated in FIG. 1, and comprises a piece of flexible film 11 with a printed aerial 12 and a microchip 13. Typically, a tag suitable for use in the applications herein specifically described will have an area of 20 mm×20 mm. The chip 13 will scarcely be thicker than the film, and will have a sub-millimetre dimension.

The chips 13 typically have eight data registers 14, of which at least one, Register A, in FIG. 2, will be 64 bits long. The number of different numbers that can be stored in such a register is in excess of 18×10¹⁸, or eighteen million million million. This register usually contains a unique code number, which is also contained in a database maintained by the chip manufacturer. The other registers, B-H, are empty, but writable.

Register B, in the example, is written to with a number derived from the Register A number by an algorithm. This is to give an instant check that the Register A number is a genuine number, without having to access the database. The algorithm will, of course, be a closely guarded secret, that cannot be deduced even by examining a lot of tags—a public/private key encryption technique can give such security, and provide other benefits, as will be explained below.

Register C is used as an incremental counter. Suppose a banknote, say, were to have an expected life involving no more than 1000 transactions, this would need to be a nine but register. It would initially contain the number 00000000000; each time the note passed through a checkpoint, this counter would be incremented by 1. So the unique code would be contained in Registers A, B and C, and would change by virtue of the number in Register C changing.

Register D can contain an indication of the date and place of the last check, represented here as a bank sort code or a code for a currency exchange or retail establishment, and a date—here, the representations are in decimal notation for ease of understanding, though, in practice, they would be in binary.

Register E can contain information about the currency and denomination of the banknote, which can be used to count a stack of mixed currency and denomination notes into separate stacks. FIG. 4 shows diagrammatically an arrangement in which a stack of notes 41 is placed in a high speed counting machine 42 which picks them off individually and reads the tags, directing the notes into bins 43 according to their currency and denomination. The machine 42 is connected to the bank's computer which uses the data from the machine and adds up the various amounts of each currency, without any need for manual sorting and counting, directs credit to an appropriate account or accounts, and passes on the data to an area hub and eventually to the host computer.

There is still further space on the chip for other information, should that be required for any reason.

FIG. 3 shows a possible structure for a database connection for a banknote authenticating system. Bank based reader/writer units 31 would be connected to the bank's internal computer 32, which would, in turn, be connected to an area hub 33 along with other banks (and currency exchanges and other places where banknotes are passed). Area hubs 33 would in turn connect to a host computer 34.

Each time a tag is read in one of the reader/writer units 31, its counter is incremented and a record of the date and time, and the place of the transaction entered. The information read from the tag, together with the new information entered thereon, is transmitted through the network up to the host computer 34, where it is checked against the database held thereon, and the new information entered. Checks can also be made in the bank's computer 32 and in the hubs 33, for repeated codes, these computers, together, of course, with the host computer 34, being programmed to detect repeats and clear them as acceptable, because of the changed information, or not acceptable, if the check shows that there are two or more instances of the incremental counter data being the same. That can happen, of course, only if there are two banknotes in circulation, one of which has been copied from the other. The information about the time and date, and the location of recent checks gives a good audit trail on which to launch an investigation.

Because the worst case scenario is that a counterfeiter would withdraw from a bank account, or from several accounts, banknotes that he could copy, information about the time and place of that or those transactions would be on the host computer, and this would probably be sufficient to pin down the counterfeiter. Moreover, having then figured out which notes are genuine and which are not, the last-known location of the counterfeit notes would be instantly known, and their reappearance from circulation could be awaited, so they could be withdrawn from circulation.

Another, incidental, advantage of the system is that, when currency is stolen, it can be readily identified, because of the audit trail, and rendered worthless by the host computer issuing instructions through the network to the bank computers.

The network can, of course, be international.

In FIG. 5, a system for passports is illustrated. A passport 51 will have a unique identifying code in Register A of an RFID tag 11, which can be supplemented by an algorithm-derived code in Register B. Examining the passport at a frontier control will involve reading the contents of Registers A and B, and reading and incrementing a counter in Register C. Time and place data can be entered, as before into Register D.

Here, the problem is somewhat simpler than for currency notes, inasmuch as a counterfeiter is unlikely to be able to secure large numbers of passports to copy genuine codes, and the algorithm-derived code in register B will almost certainly be wrong, permitting instant detection at the frontier post, without resort to the database in a host computer. What is more likely to happen is that a genuine passport will be obtained by theft, and a new photograph substituted which is a likeness of the new bearer. Registers E-H, however, can contain anthropometric data, such as locations of salient points on a fingerprint, or in iris patterns, or distance between pupil centres, the coding for these data being impenetratingly difficult. In case, however, the counterfeiter is expert enough to be able to change the register data to correspond to the anthropometric data appropriate to the new bearer, that data can be rendered inaccessible by storing it on the host computer rather than on the passport. Or one register might have information about, say, fingerprint salients, the others being blank, but, at the frontier post, the fingerprint salient data is uploaded into the host computer, where it is compared to the original data stored for that particular microchip, other data being downloaded into the chip, about, say, iris patterns, which the counterfeiter would not have been able to alter. There are thus two ways, now, of identifying a forged passport based on a genuine original, one being that changed anthropometric data does not correspond to the original held on the host computer, the other being that new, original information will be downloaded which will not check out at the next frontier post. Or, on detection of a failure to correlate old and new data, the passport can simply be cancelled, if not at the start of a journey, because of time taken to upload and download, at least before the journey's end, and the carrier arrested on arrival. To facilitate this, at the start of each joumey, when a passport is presented at check-in at an airport, for example, the flight number and destination can be entered into one of the registers.

Of course, a passport reported lost or stolen could be cancelled in any event, rendering it useless and of no value.

The considerations will apply, also, to identity cards. Indeed, an identity card and a passport could very well be the same thing, in due course. The fact that information can be written to the chip could eliminate the need to have visa stamps, so the passport booklet form will be redundant. Register space could also be allocated to driving licence details.

1. A system for authenticating re-presentable items, such as currency notes and passports, comprising applying to each item a unique code, reading the code on presentation, and checking the code against a database, characterised in that at each check, the code is altered.

2. A system according to claim 1, in which the code is comprised in an RFID tag.

3. A system according to claim 2, in which the tag has writable register means.

4. A system according to claim 1, in which at least part of the code is burnt in so that it cannot be erased or altered.

5. A system according to claim 1, in which a part of the code is the tag manufacturer's burnt in unique number.

6. A system according to claim 1, in which the code is altered by incrementing a counter at each check.

7. A system according to claim 1, in which a code derived by an algorithm from a burnt-in code is also part of the unique code.

8. A system according to claim 7, in which the code is altered to contain time and place information about the check.

9. A system according to claim 8, in which historic time and date information is written over.

10. A system according to claim 1, in which deleted or written over information is stored on the database.

11. A system according to claim 1, in which the items are currency notes.

12. A system according to claim 1, in which the items are passports or other identity cards.

13. A re-presentable item authenticated by a system according to claim 1.
